(19) United States
(12) Patent Application Publication
(10) Pub. No.: US 2024/0395081 A1
(43) Pub. Date: Nov. 28, 2024

(54) SYSTEMS AND METHODS FOR PROVIDING CUSTOMIZED DRIVING EVENT PREDICTIONS USING A MODEL BASED ON GENERAL AND USER FEEDBACK LABELS

(71) Applicant: Verizon Patent and Licensing Inc., Basking Ridge, NJ (US)

(72) Inventors: Douglas COIMBRA DE ANDRADE, Firenze (IT); Leonardo SARTI, Florence (IT); Tommaso BIANCONCINI, Florence (IT); Lorenzo MOSCHI, Firenze (IT)

(73) Assignee: Verizon Patent and Licensing Inc., Basking Ridge, NJ (US)

(21) Appl. No.: 18/321,580

(22) Filed: May 22, 2023

(51) Int. Cl. G07C 5/02; G06N 20/00; G06V 10/774; G06V 10/776; G06V 20/40; G09B 19/16

(52) U.S. Cl. CPC G07C 5/02; G06N 20/00; G06V 10/774; G06V 10/776; G06V 20/41; G06V 20/44; G06V 20/46; G09B 19/167; G08G 1/0133; G08G 1/04

(57) ABSTRACT

A device may process video data, with a feature extraction model, to generate features, and may process a customer identifier, with an embedding layer, to generate an input. The device may optimize model weights for a classifier model and a customizer model, and may process the features, with the classifier model, to generate general predictions. The device may process the features, the input, and the general predictions, with the customizer model, to generate customer predictions, and may calculate first errors for the general predictions. The device may calculate second errors for the customer predictions, and may train the classifier model and the feature extraction model with the first errors and the optimized model weights. The device may train the customizer model and the embedding layer with the second errors and the optimized model weights. The device may implement the trained classifier model, feature extraction model, customizer model, and embedding layer.

### BACKGROUND

A video system may utilize machine learning models to classify driving events (e.g., tailgating, a collision, distraction, drowsiness, and/or the like) triggered by accelerometers, front facing cameras, driver facing cameras, and/or the like. The camera or the accelerometer may identify a driving event of interest (e.g., a high acceleration value, a short following distance to another vehicle, and/or the like), and video data from the camera may be provided to the video system for further analysis.

### BRIEF DESCRIPTION OF THE DRAWINGS

FIGS. 1A-1L are diagrams of an example associated with providing customized driving event predictions using a model based on general and user feedback labels.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for providing customized driving event predictions using a model based on general and user feedback labels.

### DETAILED DESCRIPTION OF EXAMPLE EMBODIMENTS

The following detailed description of example implementations refers to the accompanying drawings. The same reference numbers in different drawings may identify the same or similar elements.

Machine learning models of a video system are trained using labels for video data, such as manual labels provided by reviewers of the video data. The reviewers may analyze a subsample of the video data, without knowing a customer (e.g., a vehicle fleet operator) associated with the video data, and may assign labels to multiple different categories. The labels may be used to train the machine learning models to produce driving event classifications (e.g., critical, high, medium, or low risk) that may be displayed to users of the video system. However, some users and customers using the video system may interpret driving events differently than the reviewers' classifications. For example, a company that transports livestock may want lower acceleration thresholds than an average acceleration threshold, or a fast delivery company, with highly trained drivers, may tolerate more severe levels of tailgating. Unfortunately, a single customer account fails to provide sufficient data to enable training a machine learning model for such use cases, and there are operational constraints associated with deploying a different machine learning model for each customer. Thus, current techniques for training machine learning models of a video system consume computing resources (e.g., processing resources, memory resources, communication resources, and/or the like), networking resources, and/or other resources associated with failing to generate accurate labels (e.g., a trustable ground truth) for the machine learning models, failing to utilize user labels to train the machine learning models, generating erroneous machine learning models based on inaccurate or incomplete labels, generating erroneous outputs with the erroneous machine learning models, and/or the like.

Some implementations described herein relate to a video system that provides customized driving event predictions using a model based on general and user feedback labels. For example, the video system may receive a customer identifier and video data identifying videos associated with driving events of vehicles associated with a customer, and may process the video data, with a feature extraction model, to generate features of the videos. The video system may process the customer identifier, with an embedding layer, to transform the customer identifier to an input that includes continuous vectors, and may optimize model weights for a classifier machine learning model and a customizer machine learning model to generate optimized model weights. The video system may process the features, with the classifier machine learning model, to generate general predictions for the videos, and may process the features, the input, and the general predictions, with the customizer machine learning model, to generate customer specific predictions. The video system may receive reviewer labels and user labels for the video data, and may calculate first errors for the general predictions based on the reviewer labels. The video system may calculate second errors for the customer specific predictions based on the user labels, and may train the classifier machine learning model and the feature extraction model, based on the first errors and the optimized model weights, to generate a trained classifier machine learning model and a trained feature extraction model. The video system may train the customizer machine learning model and the embedding layer, based on the second errors and the optimized model weights, to generate a trained customizer machine learning model and a trained embedding layer, and may implement the trained classifier machine learning model, the trained feature extraction model, the trained customizer machine learning model, and the trained embedding layer.

In this way, the video system provides customized driving event predictions using a model based on general and user feedback labels. For example, the video system may train a machine learning model that is capable of classifying a video event (e.g., a crash detection, an event severity, driver behavior, and/or the like). The video system may utilize a dataset of manually annotated data to serve as baseline for all classifications of video events. The video system may utilize customer labels generated by customer feedback to fine tune the machine learning model in a way that best suits the customer, so that the machine learning model may generate customer specific classifications. The video system may utilize the machine learning model for all customers and may utilize a customer identifier as an input to the machine learning model. The video system may determine whether the customer specific labels are to be displayed to a user of the video system. Thus, the video system may conserve computing resources, networking resources, and/or other resources that would have otherwise been consumed by failing to generate accurate labels (e.g., a trustable ground truth) for the machine learning models, failing to utilize user labels to train the machine learning models, generating erroneous machine learning models based on inaccurate or incomplete labels, generating erroneous outputs with the erroneous machine learning models, and/or the like.

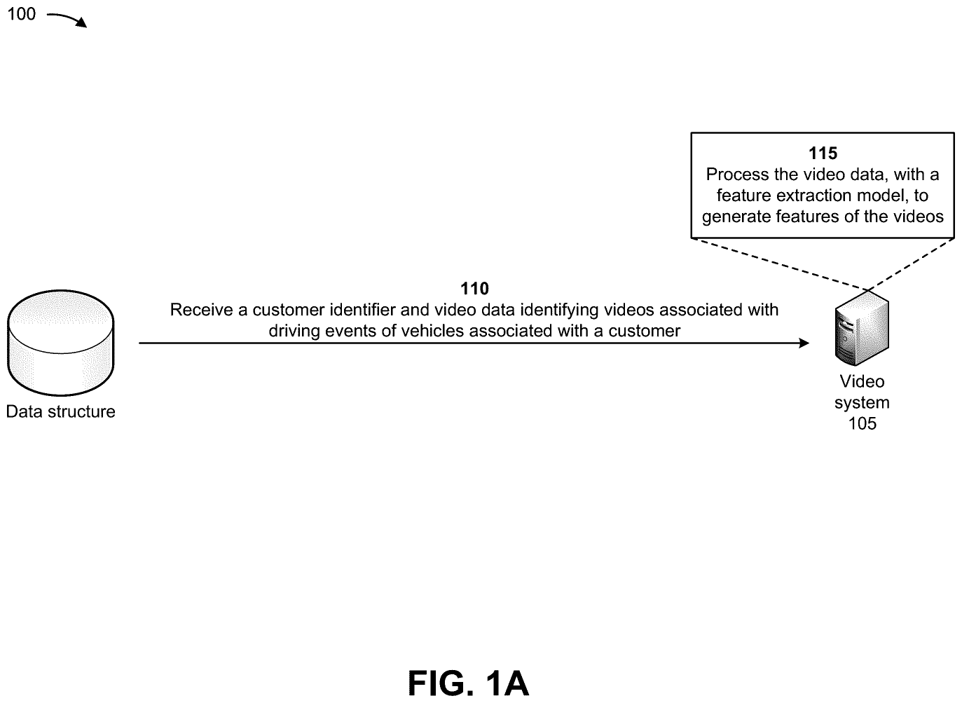

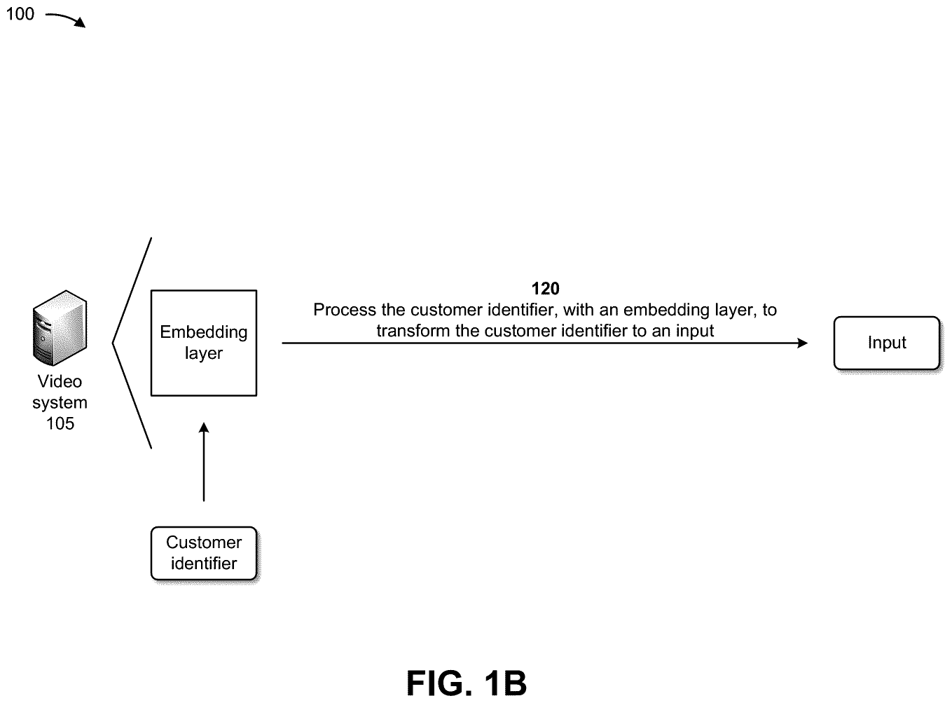

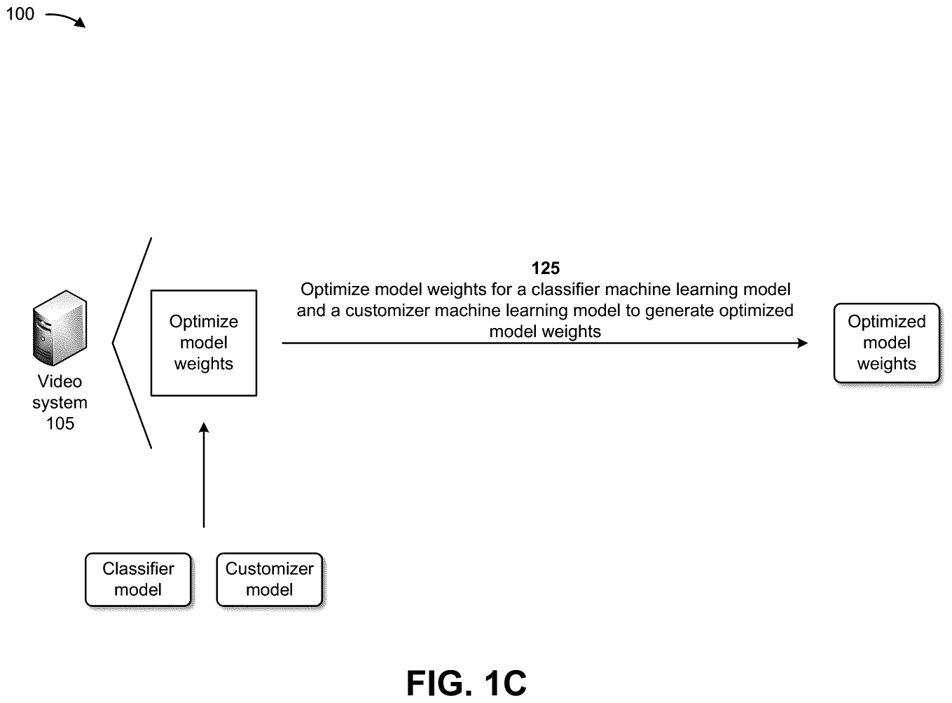

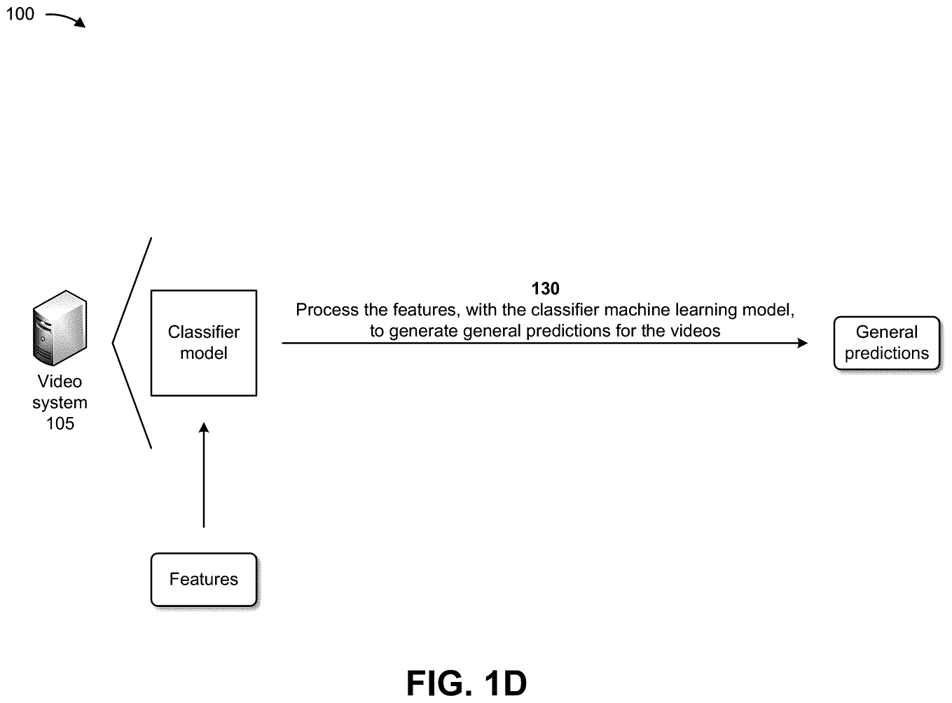

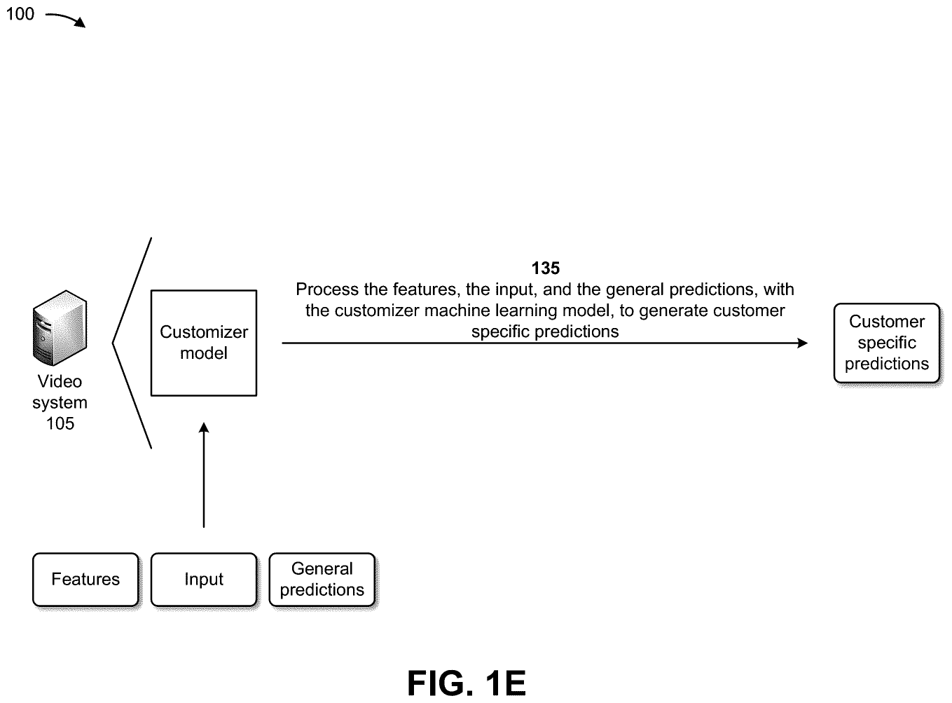

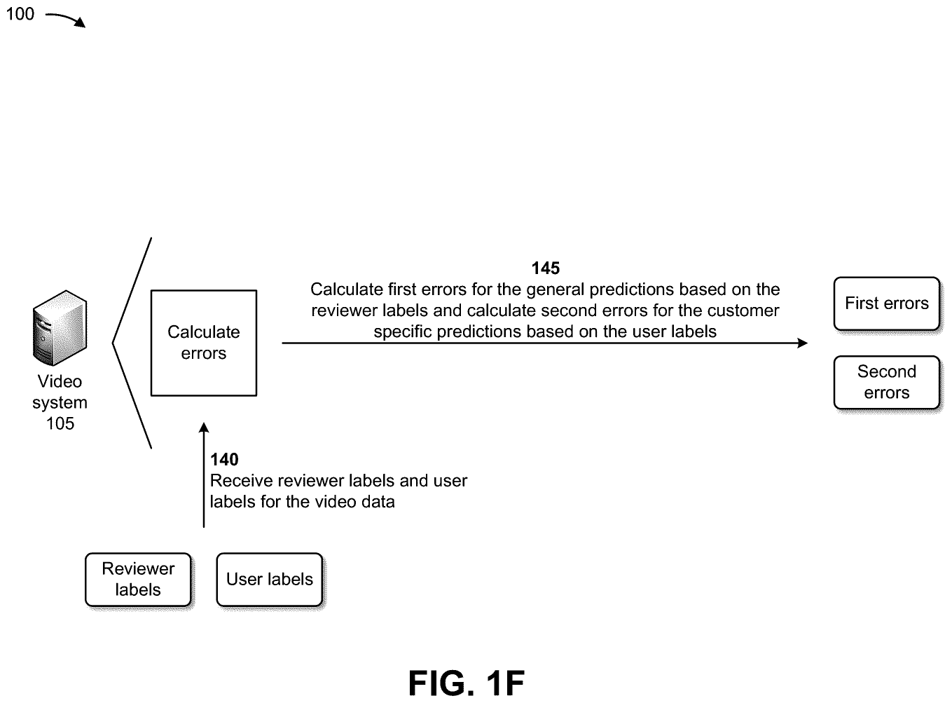

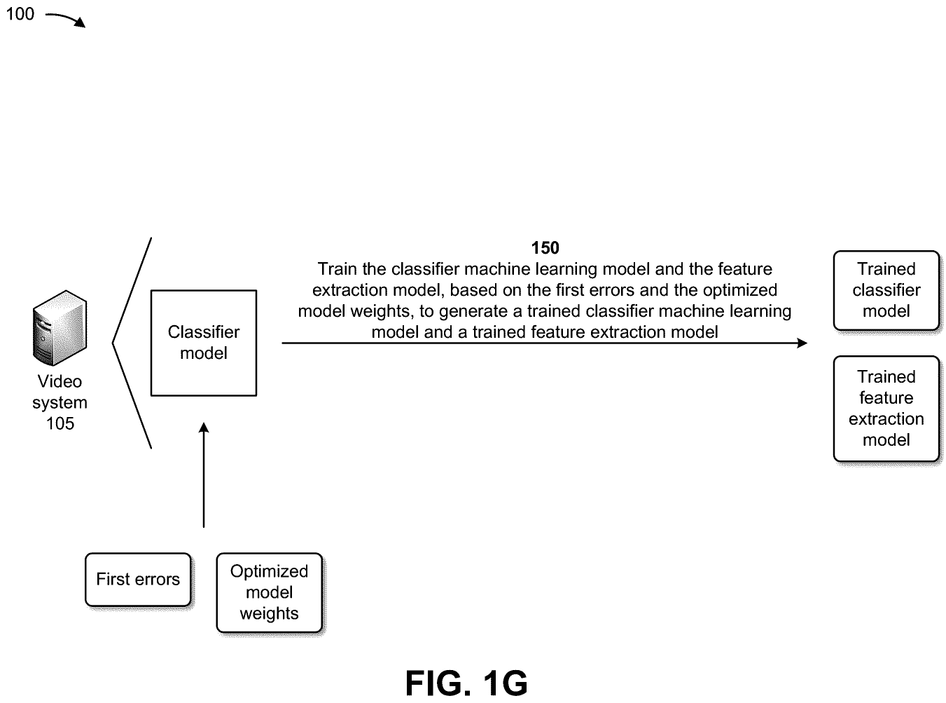

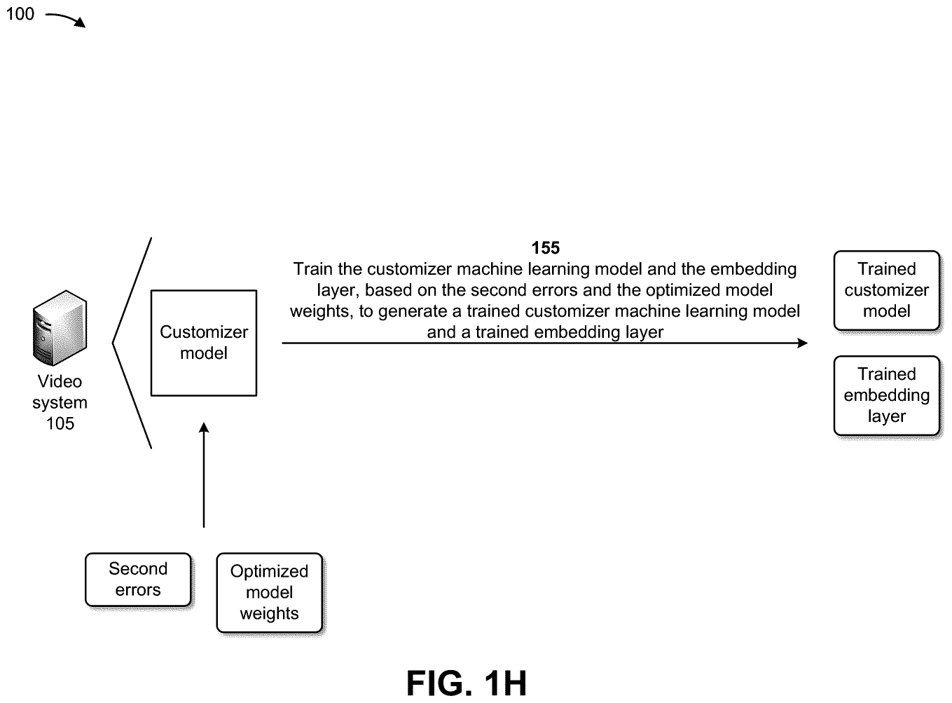

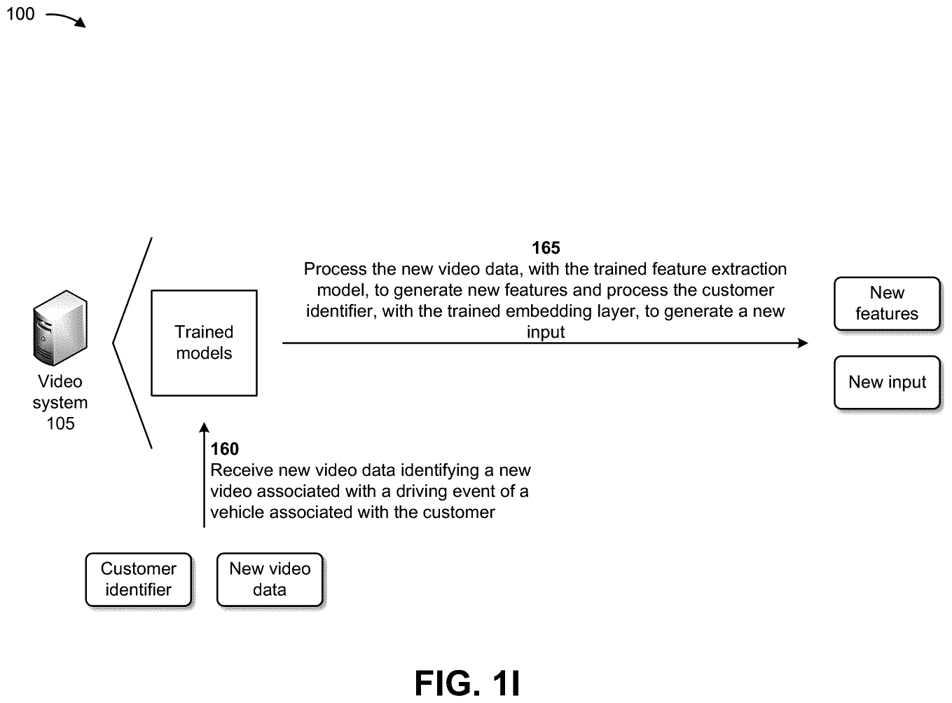

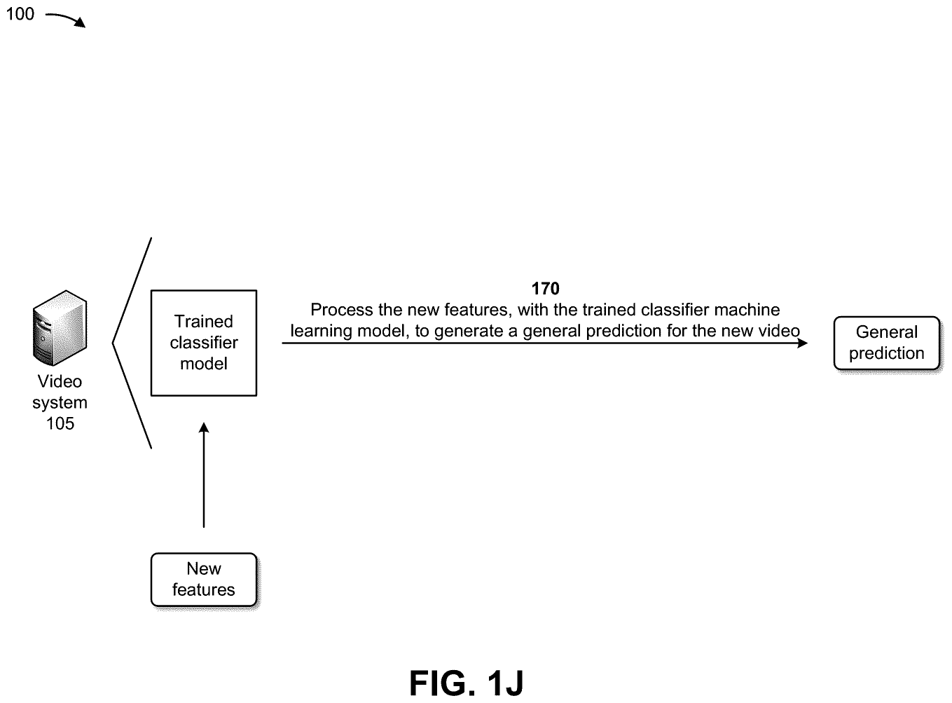

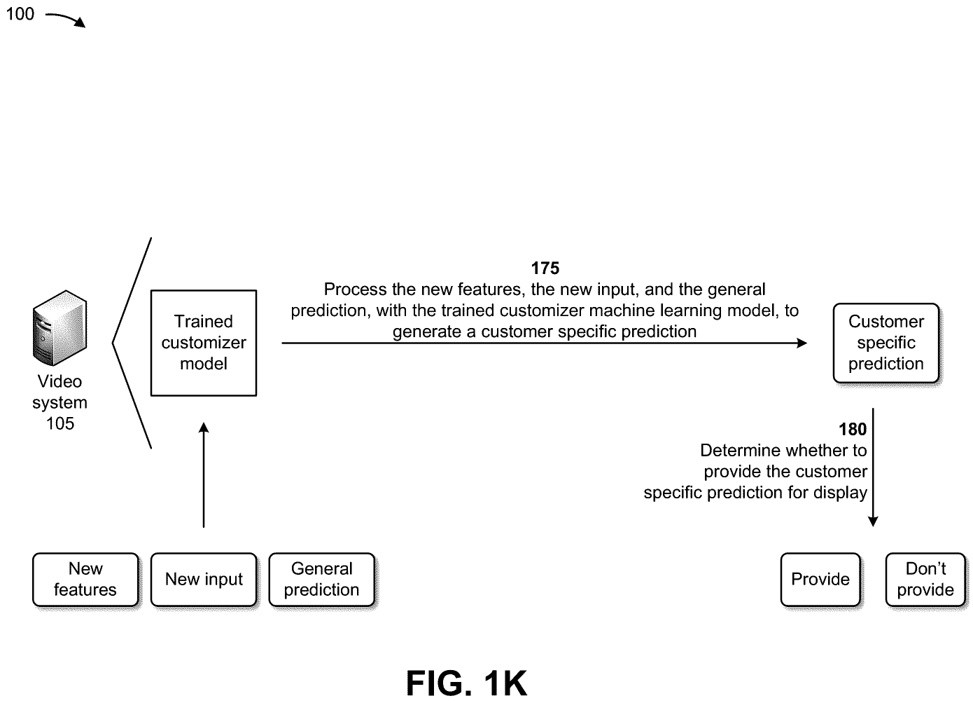

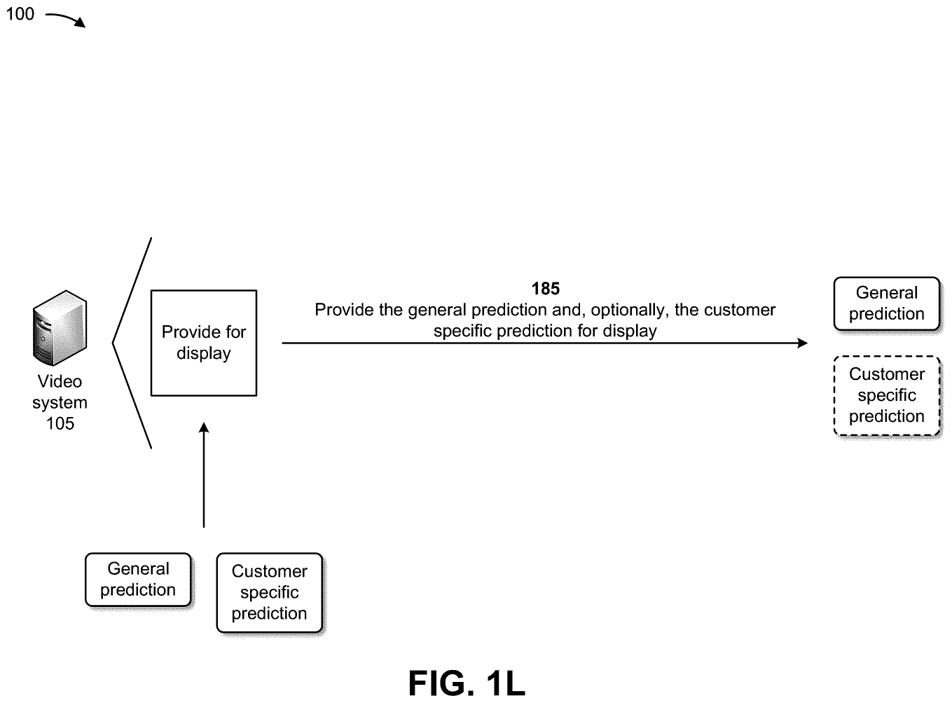

FIGS. 1A-1L are diagrams of an example 100 associated with providing customized driving event predictions using a model based on general and user feedback labels. As shown in FIGS. 1A-1L, example 100 includes a video system 105 associated with a data structure. The video system 105 may include a system that provides customized driving event predictions using a model based on general and user feedback labels. The data structure may include a database, a table, a list, and/or the like. Further details of the video system 105 and the data structure are provided elsewhere herein.

As shown in FIG. 1A, and by reference number 110, the video system 105 may receive a customer identifier and video data identifying videos associated with driving events of vehicles associated with a customer. For example, dashcams or other video devices of vehicles may record video data (e.g., video footage) of events associated with the vehicles. The video data may be recorded based on a trigger associated with the events. For example, a harsh event may be triggered by an accelerometer mounted inside a vehicle (e.g., a kinematics trigger). Alternatively, a processing device of a vehicle may include a machine learning model that detects a potential danger for the vehicle and requests further processing to obtain the video data. Alternatively, a driver of a vehicle may cause the video data to be captured at a moment that the event occurs. The vehicles or the video devices may transfer the video data to a data structure (e.g., a database, a table, a list, and/or the like). This process may be repeated over time so that the data structure includes video data identifying videos associated with driving events (e.g., for the vehicles and/or the drivers of the vehicles). In some implementations, the video data may be processed by several machine learning models that output severity scores of events (e.g., distinguishing between a critical event, a major event, a moderate event, and a minor event) and a set of additional attributes associated with the events (e.g., a presence or an absence of tailgating, a stop sign violation, a rolling stop at a traffic light, and/or the like). The machine learning models may be associated with severities and the set of additional attributes with the video data in the data structure.

In some implementations, the video system 105 may continuously receive the video data identifying videos associated with driving events from the data structure, may periodically receive the video data identifying videos associated with driving events from the data structure, or may receive the video data identifying videos associated with driving events from the data structure based on requesting the video data from the data structure.

In some implementations, different customers of the video system 105 may be associated with different sets of vehicles and may require different classifications of driving events. For example, a customer that transports livestock may want lower acceleration thresholds than an average acceleration threshold. In contrast, a rapid delivery customer with highly trained drivers, may tolerate more severe levels of tailgating before triggering higher risk event classifications. Each customer may be identified by a customer identifier, such as a numeric identifier, an alphanumeric identifier, a customer account, a customer name, and/or the like. In some implementations, the video system 105 may receive other relevant customer information (e.g., an industry type or region of a customer or other customer features) that may be used to group together small customers that alone may not provide enough feedback data to train a machine learning model. Embeddings for the customer identifier, other customer information, and other customer features may include separate learnable weights in the machine learning model.

As further shown in FIG. 1A, and by reference number 115, the video system 105 may process the video data, with a feature extraction model, to generate features of the videos. For example, the video system 105 may be associated with a feature extraction model (e.g., a convolutional neural network (CNN) model) that extracts features from an image (e.g., a frame of a video). The features may include parts or patterns of an object (e.g., a vehicle, a roadway, and/or the like) in an image that help to identify a video (e.g., a square has four corners and four edges, which are features of the square that help to identify an object as a square). The video system 105 may utilize the feature extraction model to analyze the video data and extract features of the videos from the video data. In some implementations, the features of the videos may include a vehicle type, adjacent vehicles to the vehicle, a quantity of pedestrians, a time of the day (e.g., extracted from metadata or related to lightning conditions, such as night, dawn, day, or twilight), a weather condition (e.g., sunny, overcast, rainy, foggy, or snowy), road characteristics (e.g., a quantity of lanes in a road, a one-way road versus a two-way road, a road type, traffic signal, or traffic signs), road conditions (e.g., dry, wet, or snowy), traffic conditions (e.g., a vehicle speed or a quantity of surrounding vehicles and a distance of the vehicle from the surrounding vehicles), and/or the like.

As shown in FIG. 1B, and by reference number 120, the video system 105 may process the customer identifier, with an embedding layer, to transform the customer identifier to an input. For example, the customer identifier, and other optional categorical information related to a customer (e.g., an account, a business type, a region, and/or the like), may not be in a format that is acceptable by a machine learning model. The video system 105 may utilize the embedding layer to transform the customer identifier to the input (e.g., that is acceptable by a machine learning model as a feature of the model). In some implementations, the embedding layer may transform discrete values (e.g., the customer identifier) into continuous vectors (e.g., the input). In some implementations, the video system 105 may utilize one-hot encoding or any other identifier-to-feature conversion model to transform the customer identifier to the input.

As shown in FIG. 1C, and by reference number 125, the video system 105 may optimize model weights for a classifier machine learning model and a customizer machine learning model to generate optimized model weights. For example, the video system 105 may generate the optimized model weights based on training the classifier machine learning model and the customizer machine learning model. The video system 105 may be associated with a classifier machine learning model and a customizer machine learning model. The classifier machine learning model may predict classifications of driving events in a video, and the customizer machine learning model may predict customer-specific classifications of driving events in a video.

Model weights may be associated with each of the classifier machine learning model and the customizer machine learning model. In some implementations, the video system 105 may optimize the model weights, in multiple ways, to generate the optimized model weights. In some implementations, the video system 105 may train the classifier machine learning model with a classical approach. The video system 105 may freeze the model weights of the classifier machine learning model as the embedding layer and may add customer-specific prediction layers. The video system 105 may fine tune the customer-specific prediction layers, and customer feedback data may be utilized at the fine tuning stage.

Alternatively, the video system 105 may train the classifier machine learning model with a classical approach. The video system 105 may not freeze the model weights of the classifier machine learning model as the embedding layer and may add customer-specific prediction layers. The video system 105 may fine tune the customer-specific prediction layers, and customer feedback data may be utilized at the fine tuning stage. The video system 105 may verify that an accuracy (or other relevant metrics) of the classifier machine learning model is valid.

Alternatively, the video system 105 may train the classifier machine learning model and the customizer machine learning model with review feedback (e.g., reviewer labels described below) and user feedback (e.g., user labels described below). The video system 105 may utilize ground truth data that indicates whether training data comes from the reviewers or the users (e.g., the customers) to guide back propagation, and may jointly compute and evaluate reviewer and customer data metrics.

As shown in FIG. 1D, and by reference number 130, the video system 105 may process the features, with the classifier machine learning model, to generate general predictions for the videos. For example, the classifier machine learning model may focus on a particular domain, may classify each of the videos within the particular domain (e.g., based on the features), and may assign a label to each of the videos based on the classifications. In some implementations, the classifications of the videos may be referred to as general predictions. As an example, the classifier machine learning model may assign the following risk-related labels based on an analysis of the video data (e.g., where a “0” indicates a low risk, a “1” indicates a mild violation (a mild risk), a “2” indicates a severe violation (a high risk), and a “3” indicates a collision): a tailgating severity label (e.g., 0, 1, or 2), a stop sign violation severity label (e.g., 0, 1, 2, or 3), a minor severity confidence label (e.g., from 0 to 1), a moderate severity confidence label (e.g., from 0 to 1), a major severity confidence label (e.g., from 0 to 1), a critical severity confidence label (e.g., from 0 to 4), a presence of a vulnerable road user (VRU) label (e.g., 0, 1, or 2), and/or the like.

In some implementations, the video system 105 may include other models that assign additional labels to each of the videos. The additional labels may not be related to a safety condition of an event, but may be utilized to determine a risk score and/or a similarity of a video with other videos. For example, the additional labels may include a time of the day label (e.g., extracted from metadata or related to lightning conditions, such as night, dawn, day, or twilight), a weather condition label (e.g., sunny, overcast, rainy, foggy, or snowy), a road characteristics label (e.g., a quantity of lanes in a road, a one-way road versus a two-way road, or a road type), a road conditions label (e.g., dry, wet, or snowy), a traffic conditions label (e.g., a vehicle speed or a quantity of surrounding vehicles and a distance of the vehicle from the surrounding vehicles), and/or the like.

As shown in FIG. 1E, and by reference number 135, the video system 105 may process the features, the input, and the general predictions, with the customizer machine learning model, to generate customer specific predictions. For example, the customizer machine learning model may focus on the same particular domain as the classifier machine learning model, may classify each of the videos within the particular domain (e.g., based on the features, the input, and the general predictions), and may assign a label to each of the videos based on the classifications. In some implementations, the classifications of the videos may be referred to as customer specific predictions since the input (e.g., the customer identifier) provided to the customizer machine learning model may associate the predictions with a specific customer. As an example, the customizer machine learning model may assign the following risk-related labels based on an analysis of the video data: a tailgating severity label (e.g., 0, 1, or 2), a stop sign violation severity label (e.g., 0, 1, 2, or 3), a minor severity confidence label (e.g., from 0 to 1), a moderate severity confidence label (e.g., from 0 to 1), a major severity confidence label (e.g., from 0 to 1), a critical severity confidence label (e.g., from 0 to 4), a presence of a VRU label (e.g., 0, 1, or 2), and/or the like.

As shown in FIG. 1F, and by reference number 140, the video system 105 may receive reviewer labels and user labels for the video data. For example, reviewers may analyze the video data, without knowing a customer (e.g., a vehicle fleet operator) associated with the video data, and may assign reviewer labels to multiple different categories. The reviewer labels may be used to train machine learning models to produce driving event classifications (e.g., critical, high, medium, or low) that may be displayed by the video system 105. In some implementations, the reviewers may be associated with user devices and may provide the reviewer labels to the user devices. The reviewers may cause the user devices to provide the reviewer labels to the video system 105, and the video system 105 may receive the reviewer labels from the user devices.

In some implementations, users (e.g., associated with the customer) of the video system 105 may analyze the video data, on behalf of the customer associated with the video data, and may assign user labels to multiple different categories. The user labels may be used to train machine learning models to produce driving event classifications (e.g., critical, high, medium, or low) that may be displayed by the video system 105. However, since the users may classify driving events differently than the reviewers, one or more of the user labels may be different than corresponding one or more of the reviewer labels for the same video data.

As further shown in FIG. 1F, and by reference number 145, the video system 105 may calculate first errors for the general predictions based on the reviewer labels and may calculate second errors for the customer specific predictions based on the user labels. For example, the video system 105 may compare the general predictions and the corresponding reviewer labels for the video data, and may determine whether the general predictions match (e.g., no differences) the corresponding reviewer labels based on the comparison. If the video system 105 determines that a general prediction fails to match a corresponding reviewer label (e.g., indicating that the general prediction is incorrect), the video system 105 may generate a first error indicating that the general prediction fails to match the corresponding reviewer label. The video system 105 may perform these functions for each of the videos to generate the first errors for the general predictions.

The video system 105 may compare the customer specific predictions and the corresponding user labels for the video data, and may determine whether the customer specific predictions match (e.g., no differences) the corresponding user labels based on the comparison. If the video system 105 determines that a customer specific prediction fails to match a corresponding user label (e.g., indicating that the customer specific prediction is incorrect), the video system 105 may generate a second error indicating that the customer specific prediction fails to match the corresponding user label. The video system 105 may perform these functions for each of the videos to generate the second errors for the customer specific predictions.

As shown in FIG. 1G, and by reference number 150, the video system 105 may train the classifier machine learning model and the feature extraction model, based on the first errors and the optimized model weights, to generate a trained classifier machine learning model and a trained feature extraction model. For example, the video system 105 may periodically or continuously train the classifier machine learning model and the feature extraction model, with the first errors and the optimized model weights, to generate the trained classifier machine learning model and the trained feature extraction model. The first errors and the optimized model weights may improve and/or enhance the reviewer labels and the model weights, and the video system 105 may utilize the first errors and the optimized model weights to generate a new and improved classifier machine learning model that predicts improved video classifications and a new and improved feature extraction model that more accurately identifies feature in videos. In this way, the video system 105 provides a fully automatic and continuous training pipeline for the classifier machine learning model and the feature extraction model.

As shown in FIG. 1H, and by reference number 155, the video system 105 may train the customizer machine learning model and the embedding layer, based on the second errors and the optimized model weights, to generate a trained customizer machine learning model and a trained embedding layer. For example, the video system 105 may periodically or continuously train the customizer machine learning model and the embedding layer, with the second errors and the optimized model weights, to generate the trained customizer machine learning model and the trained embedding layer. The second errors and the optimized model weights may improve and/or enhance the user labels and the model weights, and the video system 105 may utilize the second errors and the optimized model weights to generate a new and improved customizer machine learning model that predicts improved video classifications and a new and improved embedding layer that more accurately generates inputs for customer identifiers. In this way, the video system 105 provides a fully automatic and continuous training pipeline for the customizer machine learning model and the embedding layer.

As further shown in FIG. 1I, and by reference number 160, the video system 105 may receive new video data identifying a new video associated with a driving event of a vehicle associated with the customer. For example, a dashcam or another video device of the vehicle may record the new video data (e.g., video footage) of events associated with the vehicle. The new video data may be recorded based on a trigger associated with the events. Alternatively, a processing device of the vehicle may include a machine learning model that detects a potential danger for the vehicle and requests further processing to obtain the new video data. Alternatively, a driver of a vehicle may cause the new video data to be captured at a moment that the event occurs. The vehicle or the video device may transfer the new video data to the data structure or directly to the video system 105. The video system 105 may receive the new video data from the data structure or from the vehicle/video device. In some implementations, the video system 105 may continuously receive the new video data identifying the new video associated with the driving event of the vehicle associated with the customer, may periodically receive the new video data identifying the new video, may receive the new video data identifying the new video based on requesting the new video data, and/or the like.

As further shown in FIG. 1I, and by reference number 165, the video system 105 may process the new video data, with the trained feature extraction model, to generate new features and may process the customer identifier, with the trained embedding layer, to generate a new input. For example, the video system 105 may utilize the trained feature extraction model to analyze the new video data and extract features of the new video from the new video data. In some implementations, the features of the new video may include the vehicle, adjacent vehicles to the vehicle, pedestrians, a time of the day (e.g., extracted from metadata or related to lightning conditions, such as night, dawn, day, or twilight), a weather condition (e.g., sunny, overcast, rainy, foggy, or snowy), road characteristics (e.g., a quantity of lanes in a road, a one-way road versus a two-way road, a road type, traffic signal, or traffic signs), road conditions (e.g., dry, wet, or snowy), traffic conditions (e.g., a vehicle speed or a quantity of surrounding vehicles and a distance of the vehicle from the surrounding vehicles), and/or the like.

In some implementations, the video system 105 may utilize the trained embedding layer to transform the customer identifier to the new input (e.g., that is acceptable by the trained customizer machine learning model). In some implementations, the trained embedding layer may transform discrete values (e.g., the customer identifier) into continuous vectors (e.g., the new input). In some implementations, the video system 105 may utilize one-hot encoding or any other identifier-to-feature conversion model to transform the customer identifier to the new input.

As shown in FIG. 1J, and by reference number 170, the video system 105 may process the new features, with the trained classifier machine learning model, to generate a general prediction for the new video. For example, the video system 105 may utilize the trained classifier machine learning model to generate the general prediction for the new video based on the new features generated by the trained feature extraction model. The trained classifier machine learning model may focus on a particular domain, may classify the new video within the particular domain (e.g., based on the features), and may assign a label to the new video based on the classification. In some implementations, the classification of the new video may be referred to as a general prediction for the new video. As an example, the trained classifier machine learning model may assign the following risk-related labels based on an analysis of the new video data: a tailgating severity label (e.g., 0, 1, or 2), a stop sign violation severity label (e.g., 0, 1, 2, or 3), a minor severity confidence label (e.g., from 0 to 1), a moderate severity confidence label (e.g., from 0 to 1), a major severity confidence label (e.g., from 0 to 1), a critical severity confidence label (e.g., from 0 to 4), a presence of a VRU label (e.g., 0, 1, or 2), and/or the like.

As shown in FIG. 1K, and by reference number 175, the video system 105 may process the new features, the new input, and the general prediction, with the trained customizer machine learning model, to generate a customer specific prediction. For example, the video system 105 may utilize the trained customizer machine learning model to generate the customer specific prediction for the new video based on the new features generated by the trained feature extraction model, the new input generated by the trained embedding layer, and the general prediction generated by the trained classifier machine learning model. The trained customizer machine learning model may focus on the same particular domain as the trained classifier machine learning model, may classify the new video within the particular domain (e.g., based on the new features, the new input, and the general prediction), and may assign a label to the new video based on the classification. In some implementations, the classification of the new video may be referred to as a customer specific prediction for the new video since the new input (e.g., the customer identifier) provided to the trained customizer machine learning model may associate the prediction with a specific customer. As an example, the trained customizer machine learning model may assign the following risk-related labels based on an analysis of the video data: a tailgating severity label (e.g., 0, 1, or 2), a stop sign violation severity label (e.g., 0, 1, 2, or 3), a minor severity confidence label (e.g., from 0 to 1), a moderate severity confidence label (e.g., from 0 to 1), a major severity confidence label (e.g., from 0 to 1), a critical severity confidence label (e.g., from 0 to 4), a presence of a VRU label (e.g., 0, 1, or 2), and/or the like.

As further shown in FIG. 1K, and by reference number 180, the video system 105 may determine whether to provide the customer specific prediction for display. For example, the video system 105 may provide the general prediction for display to a user of the video system 105. The video system 105 may determine whether to include and display the customer specific prediction with the general prediction. In some implementations, the video system 105 may determine that the customer specific prediction is to be displayed with the general prediction. Alternatively, the video system 105 may determine that the customer specific prediction is not to be displayed with the general prediction.

When determining whether to provide the customer specific prediction for display, the video system 105 may determine whether the customer specific prediction satisfies a threshold metric (e.g., a precision, an accuracy, a score, and/or the like). The video system 105 may provide the customer specific prediction for display when the customer specific prediction satisfies the threshold metric, or may prevent the customer specific prediction from being displayed when the customer specific prediction fails to satisfy the threshold metric. For example, accuracy may be a relevant business metric in the following case:

| | Training | Test |
|---|---|---|
| Reviewer set accuracy | 94% | 89% |
| Customer set accuracy | 91% | 82% |

However, a per-customer test set breakdown may indicate accuracies, as follows: customer 1 (93% and 110 feedbacks), customer 2 (80% and 95 feedbacks), customer 3 (71% and 200 feedbacks), customer 4 (71% and 20 feedbacks), customer 5 (50% and 120 feedbacks), customer 6 (10 feedbacks), and customer 7 (0 feedbacks). In this case, if the customer requires a 70% accuracy with at least 50 feedbacks (e.g., for statistical relevance), customers 1, 2, and 3 would receive the customer specific prediction, customer 4 would not receive the customer specific prediction (e.g., not enough feedback available), customer 5 would not receive the customer specific prediction (e.g., accuracy below 70%), customer 6 would not receive the customer specific prediction (e.g., not enough feedback available), and customer 7 would not receive the customer specific prediction (e.g., no feedback).

In some implementations, the video system 105 may apply the determination of providing the customer specific prediction to different customer groups. For example, if different reclassification policies are to be applied to customers in different industries, the video system 105 may group customers belonging to the same industry. In some implementations, the video system 105 may divide a single customer into sub-customers and may apply the determination of providing the customer specific prediction to different sub-customers.

As shown in FIG. 1L, and by reference number 185, the video system 105 may provide the general prediction and, optionally, the customer specific prediction for display. For example, when the video system 105 determines that the customer specific prediction is to be provided with the general prediction, the video system 105 may provide the general prediction and the customer specific prediction for display to a user of the video system 105. Alternatively, when the video system 105 determines that the customer specific prediction is not to be provided with the general prediction, the video system 105 may only provide the general prediction for display to a user of the video system 105.

In some implementations, the customer specific prediction may include an indication of a coaching opportunity for a driver of the vehicle, for one or more reviewers of the videos, and/or the like. For example, if the customer specific prediction is significantly different than the general prediction, one or more of the reviewers may need to be retrained as to why there is a significant difference. In some implementations, the video system 105 may utilize outputs of the trained classifier machine learning model and the customizer machine learning model to group together videos with similar feedbacks, properties, and/or the like. In some implementations, the customer specific prediction may include a new customized label for the new video. The new customized label may include input textual information or may be selected from a set of previously defined labels, and may add new labels that did not previously exist.

In this way, the video system 105 provides customized driving event predictions using a model based on general and user feedback labels. For example, the video system 105 may train a machine learning model that is capable of classifying a video event. The video system 105 may utilize a dataset of manually annotated data to serve as baseline for all classifications of video events. The video system 105 may utilize customer labels generated by customer feedback to fine tune the machine learning model in a way that best suits the customer, so that the machine learning model may generate customer specific classifications. The video system 105 may utilize the machine learning model for all customers and may utilize a customer identifier as an input to the machine learning model. The video system 105 may determine whether the customer specific labels are to be displayed to a user of the video system 105. Thus, the video system 105 may conserve computing resources, networking resources, and/or other resources that would have otherwise been consumed by failing to generate accurate labels (e.g., a trustable ground truth) for the machine learning models, failing to utilize user labels to train the machine learning models, generating erroneous machine learning models based on inaccurate or incomplete labels, generating erroneous outputs with the erroneous machine learning models, and/or the like.

As indicated above, FIGS. 1A-1L are provided as an example. Other examples may differ from what is described with regard to FIGS. 1A-1L. The number and arrangement of devices shown in FIGS. 1A-1L are provided as an example. In practice, there may be additional devices, fewer devices, different devices, or differently arranged devices than those shown in FIGS. 1A-1L. Furthermore, two or more devices shown in FIGS. 1A-1L may be implemented within a single device, or a single device shown in FIGS. 1A-1L may be implemented as multiple, distributed devices. Additionally, or alternatively, a set of devices (e.g., one or more devices) shown in FIGS. 1A-1L may perform one or more functions described as being performed by another set of devices shown in FIGS. 1A-1L.

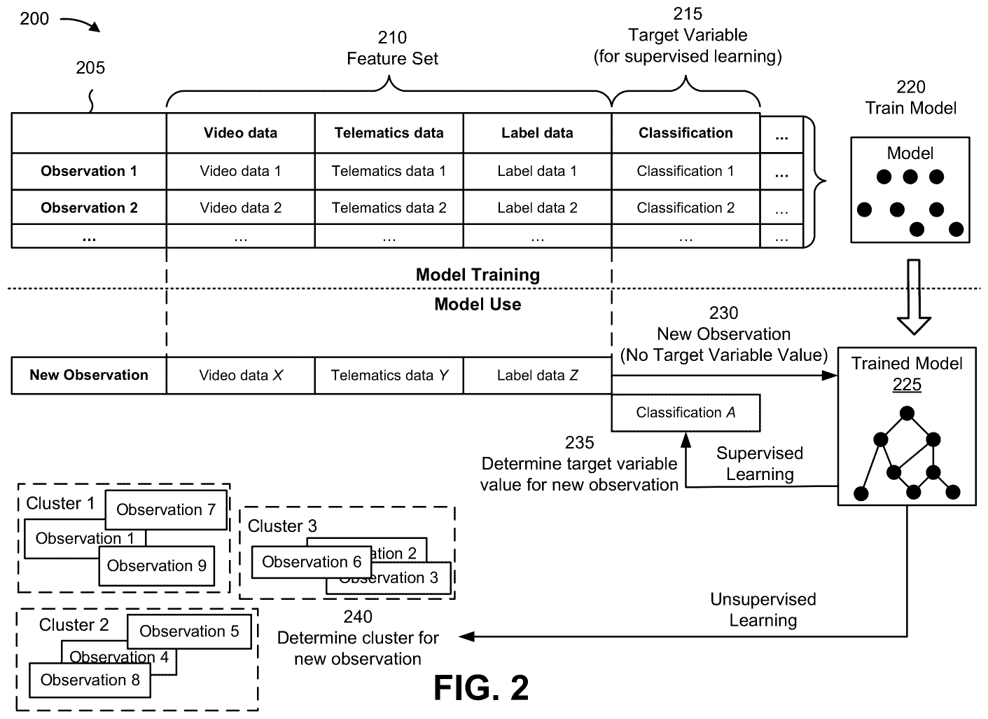

FIG. 2 is a diagram illustrating an example 200 of training and using a machine learning model. The machine learning model training and usage described herein may be performed using a machine learning system. The machine learning system may include or may be included in a computing device, a server, a cloud computing environment, or the like, such as the video system 105.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the video system 105, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the video system 105. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of video data, a second feature of telematics data, a third feature of label data, and so on. As shown, for a first observation, the first feature may have a value of video data 1, the second feature may have a value of telematics data 1, the third feature may have a value of label data 1, and so on. These features and feature values are provided as examples, and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is classification, which has a value of classification 1 for the first observation. The feature set and target variable described above are provided as examples, and other examples may differ from what is described above.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of video data X, a second feature of telematics data Y, a third feature of label data Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of classification A for the target variable of classification for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a video data cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a telematics data cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model).

In this way, the machine learning system may apply a rigorous and automated process to determine a classification of video. The machine learning system may enable recognition and/or identification of tens, hundreds, thousands, or millions of features and/or feature values for tens, hundreds, thousands, or millions of observations, thereby increasing accuracy and consistency and reducing delay associated with determining a classification of video relative to requiring computing resources to be allocated for tens, hundreds, or thousands of operators to manually determine a classification of video using the features or feature values.

As indicated above, FIG. 2 is provided as an example. Other examples may differ from what is described in connection with FIG. 2.

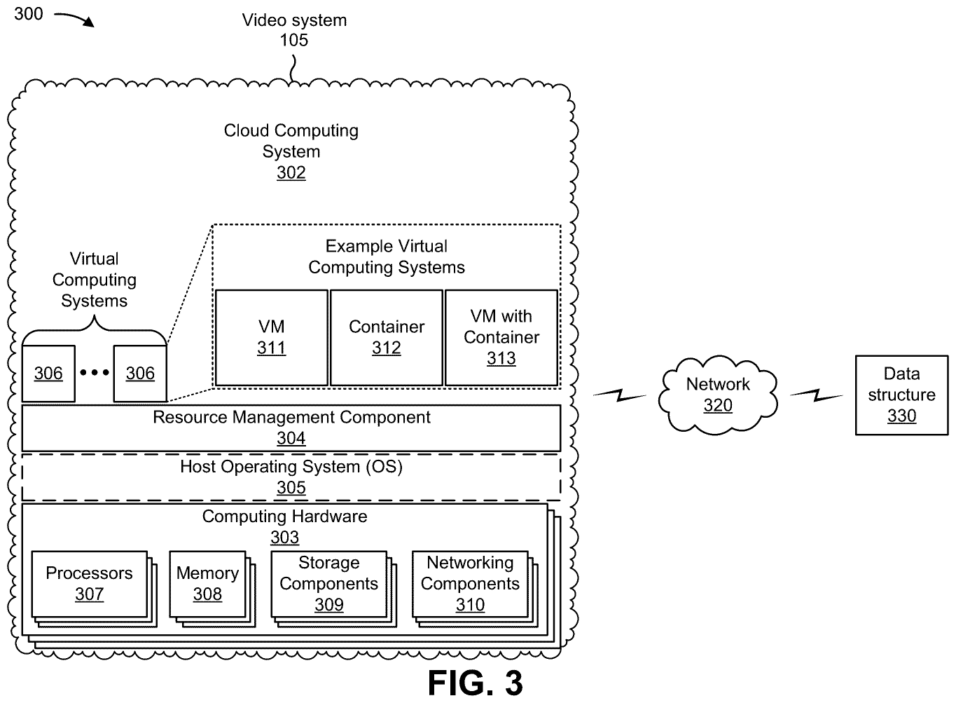

FIG. 3 is a diagram of an example environment 300 in which systems and/or methods described herein may be implemented. As shown in FIG. 3, the environment 300 may include the video system 105, which may include one or more elements of and/or may execute within a cloud computing system 302. The cloud computing system 302 may include one or more elements 303-313, as described in more detail below. As further shown in FIG. 3, the environment 300 may include a network 320 and/or a data structure 330. Devices and/or elements of the environment 300 may interconnect via wired connections and/or wireless connections.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

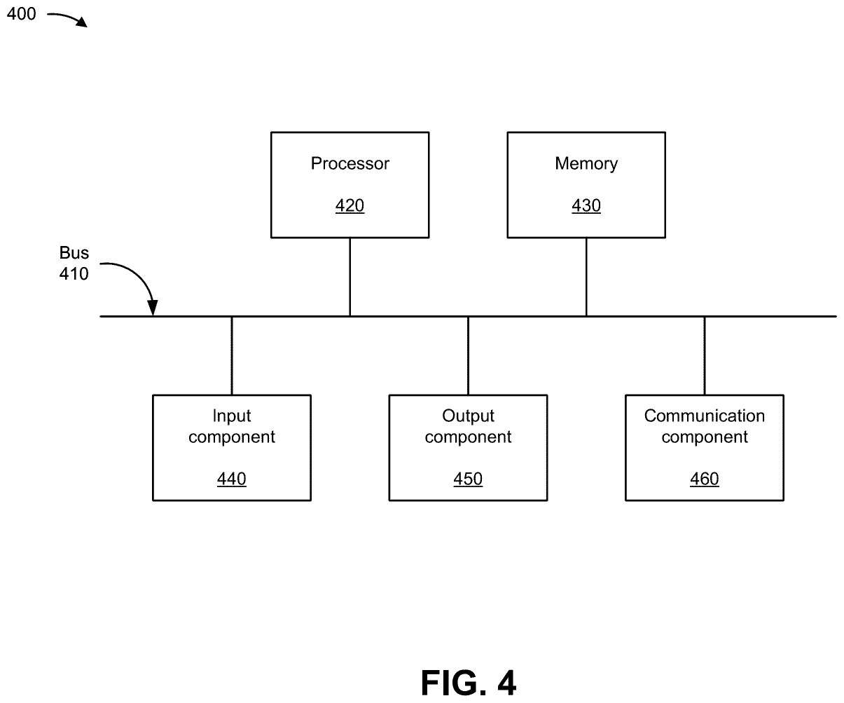

Although the video system 105 may include one or more elements 303-313 of the cloud computing system 302, may execute within the cloud computing system 302, and/or may be hosted within the cloud computing system 302, in some implementations, the video system 105 may not be cloud-based (e.g., may be implemented outside of a cloud computing system) or may be partially cloud-based. For example, the video system 105 may include one or more devices that are not part of the cloud computing system 302, such as a device 400 of FIG. 4, which may include a standalone server or another type of computing device. The video system 105 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data structure 330 may include one or more devices capable of receiving, generating, storing, processing, and/or providing information, as described elsewhere herein. The data structure 330 may include a communication device and/or a computing device. For example, the data structure 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 330 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the video system 105 and/or the data structure 330. In some implementations, the video system 105 and/or the data structure 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

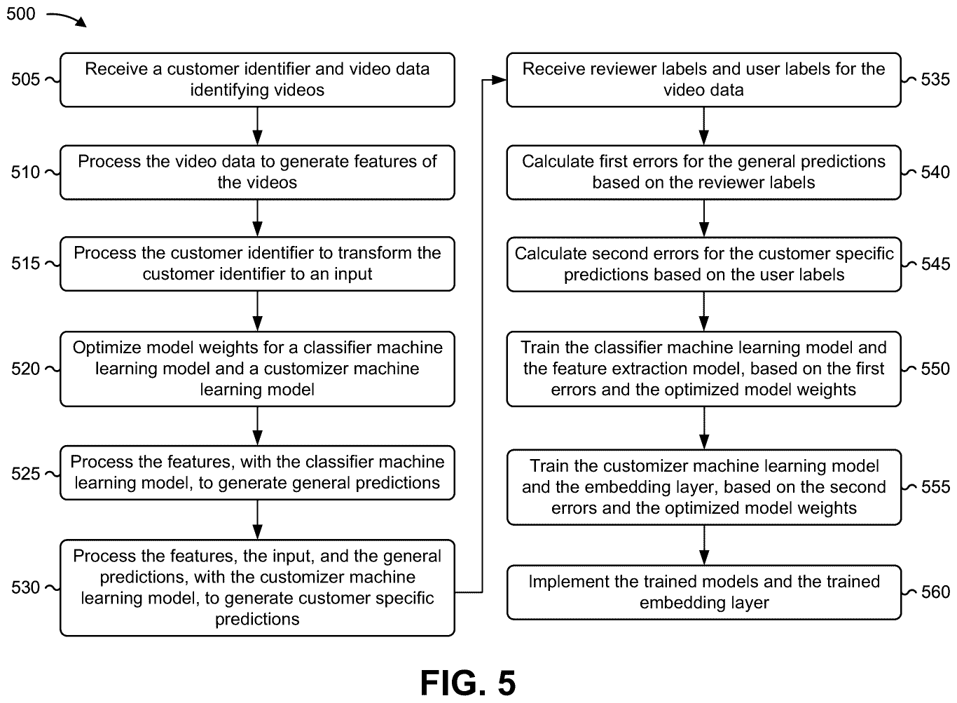

FIG. 5 depicts a flowchart of an example process 500 for providing customized driving event predictions using a model based on general and user feedback labels. In some implementations, one or more process blocks of FIG. 5 may be performed by a device (e.g., the video system 105). In some implementations, one or more process blocks of FIG. 5 may be performed by another device or a group of devices separate from or including the device. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving a customer identifier and video data identifying videos (block 505). For example, the device may receive a customer identifier and video data identifying videos associated with driving events of vehicles associated with a customer, as described above. In some implementations, the customer identifier is associated with an industry type or account information.

As further shown in FIG. 5, process 500 may include processing the video data to generate features of the videos (block 510). For example, the device may process the video data, with a feature extraction model, to generate features of the videos, as described above.

As further shown in FIG. 5, process 500 may include processing the customer identifier to transform the customer identifier to an input (block 515). For example, the device may process the customer identifier, with an embedding layer, to transform the customer identifier to an input, as described above. In some implementations, processing the customer identifier, with the embedding layer, to transform the customer identifier to the input includes processing the customer identifier, with the embedding layer, to transform the customer identifier to continuous vectors. In some implementations, processing the customer identifier, with the embedding layer, to transform the customer identifier to the input includes processing the customer identifier, with the embedding layer, to transform the customer identifier to an embedding.

As further shown in FIG. 5, process 500 may include optimizing model weights for a classifier machine learning model and a customizer machine learning model (block 520). For example, the device may optimize model weights for a classifier machine learning model and a customizer machine learning model to generate optimized model weights, as described above. In some implementations, optimizing the model weights for the classifier machine learning model and the customizer machine learning model to generate the optimized model weights includes modifying first weights associated with the classifier machine learning model to generate first modified weights, and not modifying second weights associated with the customizer machine learning model, wherein the first modified weights and the second weights correspond to the optimized model weights.

In some implementations, optimizing the model weights for the classifier machine learning model and the customizer machine learning model to generate the optimized model weights includes modifying first weights associated with the classifier machine learning model to generate first modified weights, and modifying second weights associated with the customizer machine learning model to generate second modified weights, wherein the first modified weights and the second modified weights correspond to the optimized model weights.

As further shown in FIG. 5, process 500 may include processing the features, with the classifier machine learning model, to generate general predictions (block 525). For example, the device may process the features, with the classifier machine learning model, to generate general predictions for the videos, as described above.

As further shown in FIG. 5, process 500 may include processing the features, the input, and the general predictions, with the customizer machine learning model, to generate customer specific predictions (block 530). For example, the device may process the features, the input, and the general predictions, with the customizer machine learning model, to generate customer specific predictions, as described above.

As further shown in FIG. 5, process 500 may include receiving reviewer labels and user labels for the video data (block 535). For example, the device may receive reviewer labels and user labels for the video data, as described above. In some implementations, one or more of the reviewer labels are different than one or more of corresponding user labels.

As further shown in FIG. 5, process 500 may include calculating first errors for the general predictions based on the reviewer labels (block 540). For example, the device may calculate first errors for the general predictions based on the reviewer labels, as described above. In some implementations, calculating the first errors for the general predictions based on the reviewer labels includes identifying differences between the general predictions and corresponding reviewer labels, and calculating the first errors based on the differences.

As further shown in FIG. 5, process 500 may include calculating second errors for the customer specific predictions based on the user labels (block 545). For example, the device may calculate second errors for the customer specific predictions based on the user labels, as described above. In some implementations, calculating the second errors for the customer specific predictions based on the user labels includes identifying differences between the customer specific predictions and corresponding user labels, and calculating the second errors based on the differences.

As further shown in FIG. 5, process 500 may include training the classifier machine learning model and the feature extraction model, based on the first errors and the optimized model weights (block 550). For example, the device may train the classifier machine learning model and the feature extraction model, based on the first errors and the optimized model weights, to generate a trained classifier machine learning model and a trained feature extraction model, as described above.

As further shown in FIG. 5, process 500 may include training the customizer machine learning model and the embedding layer, based on the second errors and the optimized model weights (block 555). For example, the device may train the customizer machine learning model and the embedding layer, based on the second errors and the optimized model weights, to generate a trained customizer machine learning model and a trained embedding layer, as described above.

As further shown in FIG. 5, process 500 may include implementing the trained models and the trained embedding layer (block 560). For example, the device may implement the trained classifier machine learning model, the trained feature extraction model, the trained customizer machine learning model, and the trained embedding layer, as described above. In some implementations, implementing the trained classifier machine learning model, the trained feature extraction model, the trained customizer machine learning model, and the trained embedding layer includes receiving new video data identifying a new video associated with a driving event of a vehicle associated with the customer; processing the new video data, with the trained feature extraction model, to generate new features; processing the customer identifier, with the trained embedding layer, to generate a new input; processing the new features, with the trained classifier machine learning model, to generate a general prediction for the new video, processing the new features, the new input, and the general prediction, with the trained customizer machine learning model, to generate a customer specific prediction, providing the general prediction and the customer specific prediction for display based on determining to provide the customer specific prediction for display.

In some implementations, process 500 includes determining whether the customer specific prediction satisfies a threshold metric, and determining to provide the customer specific prediction for display based on the customer specific prediction satisfying the threshold metric, or determining to not provide the customer specific prediction for display based on the customer specific prediction failing to satisfy the threshold metric. In some implementations, the customer specific prediction includes an indication of a coaching opportunity for a driver of the vehicle. In some implementations, the customer specific prediction includes a new customized label for the new video.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a customer identifier and video data identifying videos associated with driving events of vehicles associated with a customer;
processing, by the device, the video data, with a feature extraction model, to generate features of the videos;
processing, by the device, the customer identifier, with an embedding layer, to transform the customer identifier to an input;
optimizing, by the device, model weights for a classifier machine learning model and a customizer machine learning model to generate optimized model weights;
processing, by the device, the features, with the classifier machine learning model, to generate general predictions for the videos;
processing, by the device, the features, the input, and the general predictions, with the customizer machine learning model, to generate customer specific predictions;
receiving, by the device, reviewer labels and user labels for the video data;
calculating, by the device, first errors for the general predictions based on the reviewer labels;
calculating, by the device, second errors for the customer specific predictions based on the user labels;
training, by the device, the classifier machine learning model and the feature extraction model, based on the first errors and the optimized model weights, to generate a trained classifier machine learning model and a trained feature extraction model;
training, by the device, the customizer machine learning model and the embedding layer, based on the second errors and the optimized model weights, to generate a trained customizer machine learning model and a trained embedding layer; and
implementing, by the device, the trained classifier machine learning model, the trained feature extraction model, the trained customizer machine learning model, and the trained embedding layer.

2. The method of claim 1, wherein the customer identifier is associated with an industry type or account information.

3. The method of claim 1, wherein processing the customer identifier, with the embedding layer, to transform the customer identifier to the input comprises:
processing the customer identifier, with the embedding layer, to transform the customer identifier to continuous vectors.

4. The method of claim 1, wherein processing the customer identifier, with the embedding layer, to transform the customer identifier to the input comprises:
processing the customer identifier, with the embedding layer, to transform the customer identifier to an embedding.

5. The method of claim 1, wherein optimizing the model weights for the classifier machine learning model and the customizer machine learning model to generate the optimized model weights comprises:
modifying first weights associated with the classifier machine learning model to generate first modified weights; and
not modifying second weights associated with the customizer machine learning model,
wherein the first modified weights and the second weights correspond to the optimized model weights.

6. The method of claim 1, wherein optimizing the model weights for the classifier machine learning model and the customizer machine learning model to generate the optimized model weights comprises:
modifying first weights associated with the classifier machine learning model to generate first modified weights; and
modifying second weights associated with the customizer machine learning model to generate second modified weights,
wherein the first modified weights and the second modified weights correspond to the optimized model weights.

7. The method of claim 1, wherein one or more of the reviewer labels are different than one or more of corresponding user labels.

8. A device, comprising:
one or more processors configured to:
receive a customer identifier and video data identifying videos associated with driving events of vehicles associated with a customer,
wherein the customer identifier is associated with an industry type or account information;
process the video data, with a feature extraction model, to generate features of the videos;
process the customer identifier, with an embedding layer, to transform the customer identifier to an input;
optimize model weights for a classifier machine learning model and a customizer machine learning model to generate optimized model weights;
process the features, with the classifier machine learning model, to generate general predictions for the videos;
process the features, the input, and the general predictions, with the customizer machine learning model, to generate customer specific predictions;
receive reviewer labels and user labels for the video data;
calculate first errors for the general predictions based on the reviewer labels;
calculate second errors for the customer specific predictions based on the user labels;
train the classifier machine learning model and the feature extraction model, based on the first errors and the optimized model weights, to generate a trained classifier machine learning model and a trained feature extraction model;
train the customizer machine learning model and the embedding layer, based on the second errors and the optimized model weights, to generate a trained customizer machine learning model and a trained embedding layer; and
implement the trained classifier machine learning model, the trained feature extraction model, the trained customizer machine learning model, and the trained embedding layer.

9. The device of claim 8, wherein the one or more processors, to calculate the first errors for the general predictions based on the reviewer labels, are configured to:
identify differences between the general predictions and corresponding reviewer labels; and
calculate the first errors based on the differences.

10. The device of claim 8, wherein the one or more processors, to calculate the second errors for the customer specific predictions based on the user labels, are configured to:
identify differences between the customer specific predictions and corresponding user labels; and
calculate the second errors based on the differences.

11. The device of claim 8, wherein the one or more processors, to implement the trained classifier machine learning model, the trained feature extraction model, the trained customizer machine learning model, and the trained embedding layer, are configured to:
receive new video data identifying a new video associated with a driving event of a vehicle associated with the customer;
process the new video data, with the trained feature extraction model, to generate new features;
process the customer identifier, with the trained embedding layer, to generate a new input;
process the new features, with the trained classifier machine learning model, to generate a general prediction for the new video;
process the new features, the new input, and the general prediction, with the trained customizer machine learning model, to generate a customer specific prediction;
provide the general prediction and the customer specific prediction for display based on determining to provide the customer specific prediction for display.

12. The device of claim 11, wherein the one or more processors are further configured to:
determine whether the customer specific prediction satisfies a threshold metric; and
determine to provide the customer specific prediction for display based on the customer specific prediction satisfying the threshold metric; or
determine to not provide the customer specific prediction for display based on the customer specific prediction failing to satisfy the threshold metric.

13. The device of claim 11, wherein the customer specific prediction includes an indication of a coaching opportunity for a driver of the vehicle.

14. The device of claim 11, wherein the customer specific prediction includes a new customized label for the new video.

15. A non-transitory computer-readable medium storing a set of instructions, the set of instructions comprising:
one or more instructions that, when executed by one or more processors of a device, cause the device to:
receive a customer identifier and video data identifying videos associated with driving events of vehicles associated with a customer;
process the video data, with a feature extraction model, to generate features of the videos;
process the customer identifier, with an embedding layer, to transform the customer identifier to an input that includes continuous vectors;
optimize model weights for a classifier machine learning model and a customizer machine learning model to generate optimized model weights;
process the features, with the classifier machine learning model, to generate general predictions for the videos;
process the features, the input, and the general predictions, with the customizer machine learning model, to generate customer specific predictions;
receive reviewer labels and user labels for the video data;
calculate first errors for the general predictions based on the reviewer labels;
calculate second errors for the customer specific predictions based on the user labels;
train the classifier machine learning model and the feature extraction model, based on the first errors and the optimized model weights, to generate a trained classifier machine learning model and a trained feature extraction model;
train the customizer machine learning model and the embedding layer, based on the second errors and the optimized model weights, to generate a trained customizer machine learning model and a trained embedding layer; and
implement the trained classifier machine learning model, the trained feature extraction model, the trained customizer machine learning model, and the trained embedding layer.

16. The non-transitory computer-readable medium of claim 15, wherein the one or more instructions, that cause the device to optimize the model weights for the classifier machine learning model and the customizer machine learning model to generate the optimized model weights, cause the device to:
modify first weights associated with the classifier machine learning model to generate first modified weights; and
not modify second weights associated with the customizer machine learning model,
wherein the first modified weights and the second weights correspond to the optimized model weights.

17. The non-transitory computer-readable medium of claim 15, wherein the one or more instructions, that cause the device to optimize the model weights for the classifier machine learning model and the customizer machine learning model to generate the optimized model weights, cause the device to:
modify first weights associated with the classifier machine learning model to generate first modified weights; and
modify second weights associated with the customizer machine learning model to generate second modified weights,
wherein the first modified weights and the second modified weights correspond to the optimized model weights.

18. The non-transitory computer-readable medium of claim 15, wherein the one or more instructions, that cause the device to calculate the first errors for the general predictions based on the reviewer labels, cause the device to:
identify differences between the general predictions and corresponding reviewer labels; and
calculate the first errors based on the differences.

19. The non-transitory computer-readable medium of claim 15, wherein the one or more instructions, that cause the device to calculate the second errors for the customer specific predictions based on the user labels, cause the device to:
identify differences between the customer specific predictions and corresponding user labels; and
calculate the second errors based on the differences.

20. The non-transitory computer-readable medium of claim 15, wherein the one or more instructions, that cause the device to implement the trained classifier machine learning model, the trained feature extraction model, the trained customizer machine learning model, and the trained embedding layer, cause the device to:
receive new video data identifying a new video associated with a driving event of a vehicle associated with the customer;
process the new video data, with the trained feature extraction model, to generate new features;
process the customer identifier, with the trained embedding layer, to generate a new input;
process the new features, with the trained classifier machine learning model, to generate a general prediction for the new video;
process the new features, the new input, and the general prediction, with the trained customizer machine learning model, to generate a customer specific prediction; and
provide the general prediction and the customer specific prediction for display based on determining to provide the customer specific prediction for display.
